(19) United States
(12) Patent Application Publication
(10) Pub. No.: US 2025/0033629 A1
(43) Pub. Date: Jan. 30, 2025

(54) METHOD FOR OPERATING A CONTROL DEVICE OF A MOTOR VEHICLE

(71) Applicant: Brose Fahrzeugteile SE & Co. Kommanditgesellschaft, Bamberg, Bamberg (DE)

(72) Inventors: Andreas BÜHNER, Bamberg (DE); Michael NEUBAUER, Küps (DE); Burkhard WAGNER, Lichtenfels (DE); Reinhold HOPF, Küps (DE); Stefan DIESTLER, Unterleinleiter/Dürrbrunn (DE); Nils BECKER, Bayreuth (DE); Andreas DORN, Forchheim (DE); Sven WOLTER, Frensdorf (DE); Stefan HÜLDER, Dorsten (DE)

(21) Appl. No.: 18/712,866

(22) PCT Filed: Nov. 21, 2022
(86) PCT No.: PCT/EP2022/082583

§ 371 Date: Jun. 11, 2024

(30) Foreign Application Priority Data
Nov. 23, 2021 (DE) 10 2021 213 187.5

(51) Int. Cl. B60W 10/30; B60W 50/00; G06F 1/08

(52) U.S. Cl. CPC B60W 10/30; G06F 1/08; B60W 2050/0014

(57) ABSTRACT

A method for operating a control device, having a microcontroller, of a motor vehicle, in particular a door control device. Current requirements for the control device are determined by the microcontroller, and a clock frequency of the microcontroller is adapted as a function of the current requirements. There is also described a control device.

The invention relates to a method for operating a control device of a motor vehicle and to a control device. The control device in this case comprises a microcontroller.

Motor vehicles, such as passenger cars, have a large number of control devices, each of which can be used to operate assigned actuators and/or to read out assigned sensors. The control devices are in this case assigned to individual modules, which simplifies manufacture of the motor vehicle. A module of this type is, for example, a door or a door module, comprising an electric motor, which is used to drive a windowpane along an adjustment path. The request to adjust the windowpane is made by the user, usually by means of a button arranged in the interior of the motor vehicle. The operation of the electric motor depending on the actuation of the button is usually carried out by means of the assigned control device, which is therefore a door control device. In this case, anti-trap protection is usually also provided by means of the door control device, which therefore forms a constituent part of an electromotive window lifter comprising the electric motor and the windowpane. In addition, the control device is usually used to communicate with other constituent parts of the motor vehicle, in particular via a bus system.

In addition to the operation of the electromotive window lifter, the door control device is usually also used to perform other tasks assigned to this door. For example, said task is an electromotive mirror adjustment, the operation of an electric drive that can be used to pivot the entire door with respect to the motor vehicle and/or the operation of an electromotive seat adjustment system of a seat assigned to this door.

The control device usually comprises a circuit, which is used to implement the individual functions. The circuit is usually implemented by means of a microcontroller, or the circuit comprises at least the microcontroller, which is, in particular, of programmable design. Therefore, retrospective adaptation of the control device, for example in the context of a facelift or another workshop visit, is possible without a relatively high degree of outlay. It is also possible to use the same control device for different types of motor vehicle, without it being necessary to adapt the hardware. The adaptation to the respective type of motor vehicle is carried out by means of different programming and/or adaptation of parameters. As a result, it is possible to use carry-over parts, which reduces manufacturing costs of the control device.

In order to operate the control device, in particular the microcontroller, electrical energy is required. The amount of electrical energy is essentially always the same, even if there are currently no requirements present for the control device. To reduce the energy demand, it is known to transmit a command for placing the control device in what is known as standby or sleep mode, in which the microcontroller is switched off or at least the clock frequency thereof is reduced, from a higher-level control system to said control device via the bus system.

In this case, the higher-level control system usually first enquires whether there are current requirements for the control device and the command is produced only if this is not the case. As a result, on the one hand, a period of time until switch-off and thus the energy-saving mode begins is relatively long. On the other hand, a relatively large bandwidth of the bus system is required for this, which is therefore unavailable for communication elsewhere. The communication also requires additional electrical energy.

The invention is based on the object of specifying a particularly suitable method for operating a control device of a motor vehicle and a particularly suitable control device of a motor vehicle, wherein an energy demand is advantageously reduced and/or reliability is advantageously increased.

This object is achieved according to the invention for the method by the features of claim 1 and for the control device by the features of claim 8. Advantageous developments and designs are the subject matter of the respective subclaims.

The method is used to operate a control device of a motor vehicle. The motor vehicle is, in particular, of land-based and preferably multi-track design. In this case, it is suitably possible to substantially freely position the motor vehicle, in particular in an appropriate lane. For this purpose, the motor vehicle expediently comprises appropriate wheels. In summary, it is preferably possible to position the motor vehicle on land substantially irrespective of other conditions. In other words, the motor vehicle is suitably not a rail-guided vehicle. The motor vehicle is preferably a passenger car or a commercial vehicle, such as a truck or bus.

The control device is used to operate an actuator/actuators, such as an electric motor, connected to said control device. In this case, a setpoint specification for the electric motor is produced, for example, by means of the control device, wherein the electric motor is energized by means of another component in accordance with the setpoint specification. As an alternative thereto, an electric current, in particular an alternating current, is also produced by means of the control device, which for this purpose comprises, for example, a corresponding controller and/or a bridge circuit. As an alternative thereto or in combination therewith, the control device is used to read out a sensor or a plurality of sensors and, in particular, to evaluate the measurement data produced by means of the sensor and based on which a corresponding actual value is determined. In other words, the control device is used to determine a value corresponding to the respective sensor based on the measurement values therefrom.

As an alternative thereto or in combination therewith, the control device is used to operate a bus system that is connected thereto, wherein the control device functions, in particular, as a master of the bus system. The bus system is, in particular, a subsidiary bus system of the motor vehicle. As an alternative thereto or in combination therewith, the control device is used to retrieve a switch state of a switch. In this case, the control device is suitable, in particular provided and set up, for the corresponding tasks for which it is used.

The control device comprises a microcontroller, which comprises, in particular, a processor, and which is preferably of programmable design. In particular, the microcontroller additionally has peripheral functions, such as a storage unit, for example. The microcontroller is preferably partly, preferably fully, implemented by means of a chip. The microcontroller is operated at a particular clock frequency, wherein, in particular, a number of processed commands is specified depending on the clock frequency.

The control device furthermore comprises, for example, other constituent parts, such as, in particular, a communication interface, which is used for communication with a higher-level control system, for example. The communication interface is preferably a bus interface, which, for example, meets a particular standard, such as the CAN bus standard or the FlexRay standard, for example.

The control device suitably has a plurality of inputs and/or outputs to which, in particular, at least the actuator/sensor is connected in the assembled state. The inputs/outputs are suitably signally connected to the microcontroller. During operation, the microcontroller is used, in particular, to retrieve the inputs and/or to provide data/a particular electrical voltage at one of the outputs. For this purpose, other constituent parts of the control device are actuated by means of the microcontroller, for example, such that the particular electrical voltage is applied to the respective output. In particular, the control device has a controller, a bridge circuit and/or a driver circuit, which are subjected to open-loop and/or closed-loop control, in particular by means of the microcontroller. At least several of these components are preferably arranged together with the microcontroller on a printed circuit board, which simplifies manufacture and assembly.

The method makes provision for current requirements for the control device to be determined first by means of the microcontroller. In other words, it is checked whether current requirements, that is to say at least one current requirement, are present at the control device and thus also at the microcontroller, that is to say tasks that are currently to be processed by the control device. For this purpose, in particular, a load of the microcontroller, another load of the control device and/or a list of tasks is/are determined.

A clock frequency of the microcontroller is adapted depending on the current requirements. In this case, for example, the clock frequency of the possible processor is adapted. For example, the clock frequency of one core or all of the cores of the processor is changed here. As an alternative thereto or in combination therewith, the clock frequency of peripheral constituent parts of the microcontroller is changed, such as, in particular, the possible storage unit. As an alternative thereto or in combination therewith, an interface clock or a so-called PLL clock is adapted.

The clock frequency is expediently reduced if there are only low current requirements for the control device, that is to say if the current requirements are such that relatively little computation power is necessary therefor, and/or the number of current requirements is relatively low. There is a reduction, in particular, to a minimum value or at least a decreased value, with this value, however, preferably being greater than 0 Hz, such that the microcontroller also continues to operate. Thus, for example, if only housekeeping functions or operating system tasks are present as the current requirement, a decreased, in particular minimum, clock frequency is used. In other words, the decreased clock frequency is used in the presence of tasks that are brought about, in particular, by the operating system, that is to say, in particular, so-called operating system tasks.

In contrast, in the case of relatively high current requirements, the clock frequency is increased, in particular to a maximum value, for example if there is a particular type of current requirement present. These are, in particular, computation-intensive current requirements and/or time-critical current requirements, or there is a relatively large number of current requirements present.

By virtue of the method, the clock frequency, and therefore also the energy demand, is therefore reduced when this is possible based on the current requirements, that is to say, in particular, when the control device is not currently being used. There is therefore a reduced energy demand. In contrast, when corresponding current requirements do exist, the clock frequency is expediently increased, with the result that the current requirements are processed within a relatively short time frame, which increases reliability.

The clock frequency of the microcontroller is changed in this case by means of the microcontroller itself. In other words, the current requirements are determined locally in the control device and consequently the clock frequency is adapted locally. Therefore, relatively time-intensive and energy-intensive communication with a higher-level control system is not required. A timely reaction to changing current requirements by means of the control device is also possible. In addition, a required bandwidth for communication with a possible higher-level control system is reduced, which is therefore available for other purposes. It is also possible to dimension a communication path of this type, in particular a bus system, to be smaller, which also leads to a reduced energy demand.

For example, the control device is a constituent part of an ancillary unit of the motor vehicle that is used to provide comfort functions, for example. In particular, the control device is assigned to a seat and, in particular, seat functions are carried out by means of the control device. In this case, in particular, one or more electric motors assigned to the seat are operated, for which an energization process is carried out, for example, or at least one setpoint value specification for the energization is specified, for example a rotational speed. In this case, the seat or parts of the seat, such as a backrest or a headrest, are adjusted by means of the electric motors. As an alternative thereto or in combination therewith, a massage function is carried out on the electric motor or at least one of the electric motors that are operated by means of the control device.

In another alternative, the control device is assigned to a tailgate and is therefore a tailgate control device. This is used, in particular, to operate an electric motor by means of which the tailgate is pivoted with respect to a body of the motor vehicle.

Particularly preferably, however, the control device is a door control device, which is assigned to a door of the motor vehicle, preferably a side door. In particular, an electromotive window lifter is assigned to the door, and an electric motor of the electromotive window lifter is operated by means of the door control device. The control device particularly preferably comprises an anti-trap protection system, which is implemented, in particular, by means of particular routines of the microcontroller. The anti-trap protection system in this case is used to prevent an object from becoming trapped by the windowpane when it is adjusted. For this purpose, an electric current directed by means of the electric motor and/or another value characterizing the force currently applied by the electric motor is expediently evaluated at least in part. As an alternative thereto or, particularly preferably, in combination therewith, an electrically adjustable side mirror is operated by means of the door control device, wherein, for example, the door control device is used to produce a specification for the electric motor, which is used to drive a mirror. The door control device is preferably used to control heating of the mirror. For example, in addition or as an alternative, the door control device is used to activate a lock assigned to the door and/or an electric motor by means of which the door can be pivoted with respect to a body. The control device is expediently used to read out sensors, in particular switches or buttons, by means of which a request to activate the respective electric motor can be produced by a user, that is to say, in particular, to adjust the windowpane, the mirror or the entire door.

For example, the clock frequency is adapted continuously depending on the current requirements, in particular between 0 MHz and a maximum frequency. Particularly preferably, however, there are only discrete different levels for the clock frequency between which there is a changeover depending on the current requirements. For example, are present between 2 such levels and 10 such levels and precisely 2, 3, 4 or 5 such levels. This simplifies operation of the microcontroller. The formation of artifacts during operation is also prevented. For example, only two such levels are present, with one level corresponding to the maximum clock frequency and the other level corresponding to the minimum clock frequency of the microcontroller, each of which can be used to effect operation. For example, the minimum clock frequency is 30 MHz and the maximum clock frequency is equal to 120 MHz. If there are no other current requirements, with the exception of operating system tasks, the lower level is selected, that is to say, in particular, 30 MHz. If there are current requirements in addition thereto, the higher level is preferably used, in particular 120 MHz. Therefore, only a low number of hardware resources are required to carry out the method. The method is also relatively robust, with energy still being saved.

If the microcontroller comprises a plurality of processor cores, the clock frequency is adapted, for example, by all of the processor cores or only by some of the processor cores. In particular, the clock frequency is not reduced only in the case of one of the processor cores, such that any current requirements arising in the short term can be processed by means of said processor core within a short period. The energy demand is therefore reduced but with resources still being kept available by means of said processor core, resulting in reliability and/or losses of comfort.

For example, the current requirements are determined only once, for example when the motor vehicle is started. Particularly preferably, however, the current requirements are determined continuously. For this purpose, for example, a current list of tasks for the microcontroller is checked continuously or this is particularly preferably performed cyclically, that is to say in each case after a particular period has elapsed. In this case, in particular, a value between 0.5 ms and 100 ms and, in particular, 1 ms, 10 ms or 100 ms is used as the particular period. In this way, the outlay for determining the current requirements is relatively low, with a relatively quick reaction to changing current requirements still being possible.

For example, the clock frequency is reduced essentially immediately if the current requirements are reduced, that is to say, in particular, when a computation time for processing the current requirements and/or the number of current requirements is reduced. Particularly preferably, however, the reduction is effected only after a period of time, such that hysteresis is implemented. In other words, even if the current requirements have changed such that there are no or only a few current requirements present, for example, the clock frequency is reduced only after a period of time. As a result, when new requirements are produced due to the previous processing of the current requirements, there is enough computation power to process these at short notice as well. In addition, the clock frequency is therefore not changed excessively frequently, which reduces the outlay required to change the clock frequency. In summary, the clock frequency is reduced only when there are also no other current requirements for this period. As a result, the clock frequency does not oscillate, which reduces the load on the microcontroller.

For example, the clock frequency is increased only after another period of time, after corresponding current requirements are produced. Particularly preferably, however, the clock frequency is increased essentially immediately, such that when new current requirements exist, they are processed essentially immediately. As a result, due to the method, there are no losses of comfort for the user, and reliability is increased.

For example, the clock frequency of the microcontroller is left at a minimum while there are no corresponding current requirements. Particularly preferably, however, a self-test is used cyclically as the current requirement, such that at least the clock frequency is changed cyclically, in particular to the maximum. In other words, it is ensured that current requirements that lead to an increase in the clock frequency exist cyclically. In particular, the self-test is carried out after a respective period that is, in particular, between 1 second and 10 seconds and, for example, between 3 seconds and 7 seconds and, in particular, is 5 seconds. Therefore, it is ensured every 5 seconds that uninterrupted operation of the control device also continues to be possible despite the reduction in the clock frequency.

In particular, as part of the self-test, there is a check of the potential inputs and/or outputs of the control device that are not checked, for example, when there are no corresponding current requirements present. As a result, after the respective period of time has elapsed, the inputs and outputs are checked, such that it is then determined no later than this whether a value present there has changed. In summary, in particular, during the self-test, peripheral devices that are connected are checked. This increases reliability. The duration of the self-test is specified, for example, based on the possible peripheral devices. In particular, the duration of the self-test is between 100 ms and 200 ms and, for example, is equal to 150 ms. If, for example, a malfunction occurs due to the reduction in the clock frequency, this is identified during the self-test, such that a corresponding notification can be sent to a higher-level control system, for example. After the self-test has been carried out, there is also a new check to determine whether other current requirements are present and, if this is not the case, the clock frequency is reduced again accordingly.

For example, the current requirements are adapted only depending on signals or other values that can be produced by means of the control device itself and/or that are applied to the possible inputs and outputs. Particularly preferably, however, messages that are received via a bus system are also used to adapt the current requirements. For example, in this case, one or more of the messages relate to the control device or none of the messages based on which the adaptation takes place relates to the control device. The bus system is, in particular, a CAN or FlexRay bus system, and the control device is preferably connected to the possible higher-level control system, such as an on-board computer, via the bus system. In particular, the control device is in this case a slave device of the bus system.

For example, when only status requests are received as messages, the current requirements are adapted in such a way that the clock frequency is reduced. For example, for this purpose, the majority of the current requirements are deleted so that they only have, in particular, only by means of operating system tasks or housekeeping tasks. As an alternative thereto or in combination therewith, for example, when it is communicated via the bus system that the motor vehicle is at a standstill, the current requirements are also adapted accordingly. Thus, for example, in the case of a standstill and, in particular, when the ignition is switched off, it is assumed that a door will soon be activated, such that the current requirements comprise preparation to open the door, for example. As an alternative thereto or in combination therewith, for example, the readiness to adjust the door and/or to open the window is deleted from the current requirements from a particular vehicle speed, such that the clock frequency is reduced, for example.

For example, only the clock frequency of the microcontroller is reduced depending on the current requirements. Particularly preferably, however, an operating mode of a peripheral device is also changed depending on the current requirements, with the peripheral device being subject to open-loop and/or close-loop control, in particular, by means of the microcontroller. In this case, the peripheral device is, for example, a storage unit, a driver module, another microcontroller or a subsidiary bus system, that is to say a bus system that is operated by means of the control device, with the control device functioning, in particular, as master. When the operating mode is changed, for example, the peripheral device is switched off completely, such that it initially is no longer usable. As a result, an energy demand is relatively extensively reduced. As an alternative thereto, the respective peripheral device is set to a standby operating mode or at least an operating mode with a reduced energy consumption when there are no current requirements for said peripheral device or these requirements are comparatively not very computation-intensive. Only when the current requirements change and, in particular, the peripheral device is to be used based on this is the operating mode of the peripheral device, in particular, changed again, such that, in particular, it is operated at full power. The change in the operating mode is expediently initiated by means of the microcontroller. Since the peripheral device is controlled by means of the microcontroller, the knowledge about whether the peripheral device is currently used or not is available in said microcontroller.

For example, the clock frequency is adapted depending on the current requirements by means of specified rules. These are specified by the manufacturer and/or can be adapted by the user, for example. Particularly preferably, however, a neural network, that is to say an artificial intelligence algorithm (AI), is used to adapt the clock frequency depending on the current requirements. In this way, it is possible to operate the control device depending on the respective user of the motor vehicle, such that, on the one hand, an energy demand is relatively low. On the other hand, in this way there are no losses of comfort for the respective user, with there being no need for a relatively complex adaptation of the control device by the user or another person themselves.

The neural network is expediently a constituent part of the control device. A bandwidth during communication is therefore reduced. The neural network is preferably trained by means of the microcontroller. The training is expediently used as a current requirement, as long as the neural network is not fully trained. The training preferably takes place when there are no other current requirements, with the exception of the possible operating system task/housekeeping functions. In other words, the training is then used as a current requirement. As a result, computation time of the microcontroller that is not otherwise used is used for training. There are therefore no losses in terms of reliability or comfort due to the training of the neural network.

The control device is a constituent part of a motor vehicle, such as a passenger car, a truck or bus. The control device comprises a microcontroller, which comprises, in particular, a microprocessor or is formed thereby. In particular, the microcontroller is a computer or comprises a computer. The computer is suitably of programmable design. In particular, the control device comprises a storage medium on which a computer program product, which is also referred to as computer program, is stored, wherein, when said computer program product, that is to say the program, is executed, the computer is prompted to carry out a method for operating a control device of a motor vehicle having a microcontroller. At least, however, the control device is operated in accordance with the method and is therefore suitable, and in particular provided and set up, for this purpose. According to the method, current requirements for the control device are determined by means of the microcontroller and a clock frequency of the microcontroller is adapted depending on the current requirements.

The control device is, in particular, a constituent part of an ancillary unit of the motor vehicle and, for example, a seat control device or tailgate control device. Preferably, however, the control device is a door control device and suitably is a constituent part of a door or at least a door module. The door or the door module preferably comprises an electromotive window lifter, an electrically adjustable (electrical/electromotive) side mirror, a lock and/or several input apparatuses/operating elements, such as switches and/or buttons, for example. In this case, these are each expediently operated by means of the door control device. The invention furthermore relates to a door/door module having a door control device of this type.

The invention also relates here to a computer program product comprising a number of commands which, when a computer executes the program (computer program product), prompt said computer to carry out a method for operating a control device of a motor vehicle having a microcontroller. In the method, the microcontroller is used to determine current requirements for the control device and a clock frequency of the microcontroller is adapted depending on the current requirements. The computer is expediently a constituent part of the control device or electronics system and, for example, is formed thereby. The computer is preferably formed at least in part, preferably in full, by the microcontroller. The computer preferably comprises a microprocessor or is formed thereby. The computer program product is, for example, a file or a data carrier containing an executable program that automatically executes the method when it is installed on a computer.

The invention furthermore relates to a storage medium on which the computer program product is stored. A storage medium of this type is, for example, a CD-ROM, a DVD or a Blu-ray disk. As an alternative thereto, the storage medium is a USB stick or another storage unit, which, for example, is rewritable or can only be written to once. Such a storage unit is, for example, a flash storage unit, a RAM or a ROM.

The developments and advantages explained in connection with the method can also be applied mutatis mutandis to the control device/the computer program product/the storage medium and also to one another, and vice versa.

An exemplary embodiment of the invention is explained in more detail below on the basis of a drawing. In the drawing:

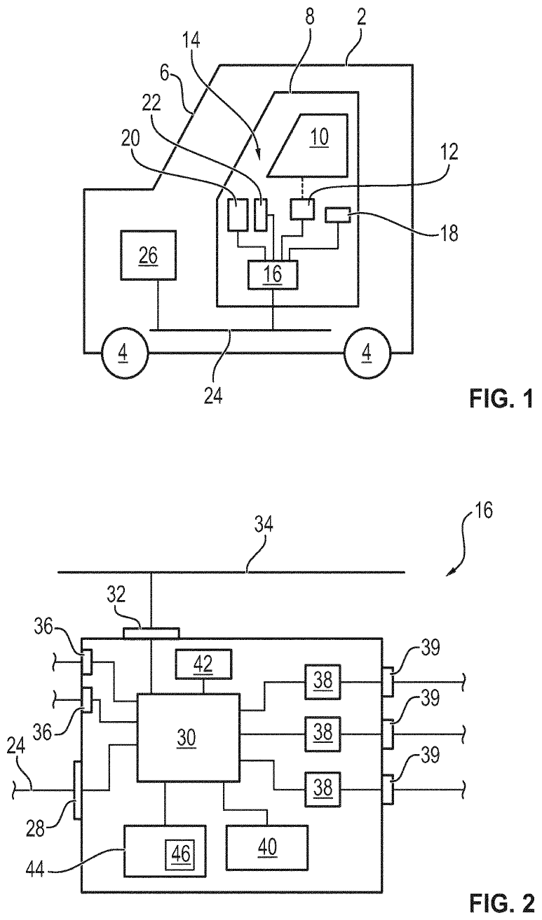

FIG. 1 schematically shows a motor vehicle with a door, which has a control device,

FIG. 2 schematically shows the control device, which comprises a microcontroller,

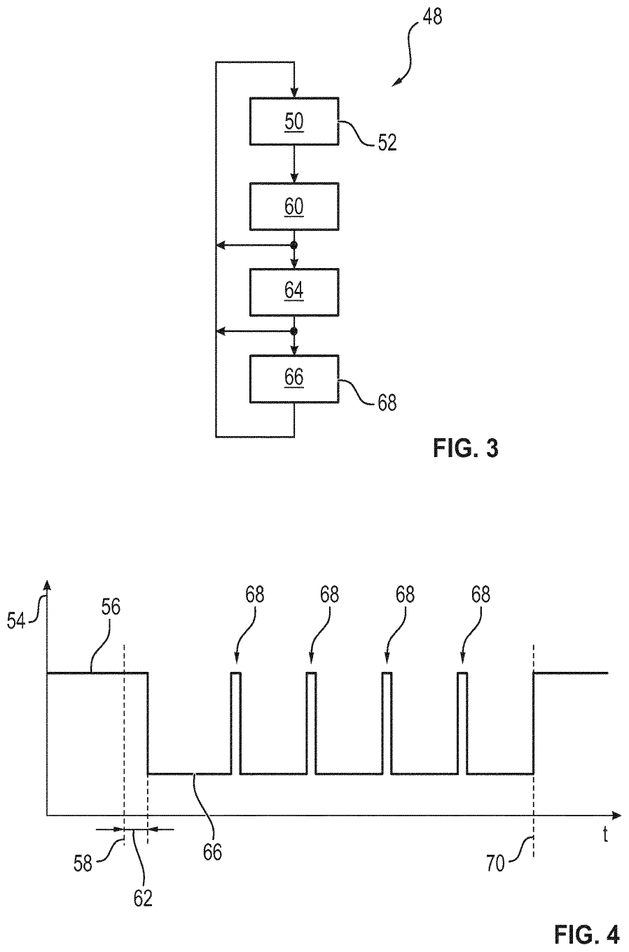

FIG. 3 shows a method for operating the control device, and

FIG. 4 shows the time profile of a clock frequency of the control device.

Parts that correspond to one another are provided with the same reference signs in all the figures.

FIG. 1 shows a schematically simplified view of a motor vehicle 2 in the form of a passenger car. The motor vehicle 2 has multiple wheels 4, by means of which contact is made with a roadway. The wheels 4 are connected to a body 6 of the motor vehicle 2 via a chassis. A door 8 in the form of a side door, specifically a driver's door, is pivotably mounted on the body 6 by means of a bearing, which is not shown in any more detail. The door 8 has a windowpane 10, which is driven by means of an electric motor 12, such that the windowpane 10 can be brought from an open to a closed position and vice versa by means of the electric motor 12.

The windowpane 10 and the electric motor 12 are constituent parts of an electromotive window lifter 14, which is operated by means of a control device 16 or which comprises the control device 16. The control device 16 is also a constituent part of the door 8 and is consequently a door control device. During operation, energization of the electric motor 12 is initiated by means of the control device 16 and, in particular, a setpoint specification for an electrical voltage, which is applied to the electric motor 12 and which is applied by means of an appropriate control unit/controller, is specified. If the electric motor 12 is of brushless design, a converter, by means of which the electric motor 12 is energized and which is not illustrated in more detail, is suitably actuated by means of the control device 16. In addition, the control device 16 is used to provide anti-trap protection, which is used to monitor whether the windowpane 10 comes into contact with an object when it is adjusted. If this is detected, the electric motor 12 is shut down, thus preventing the object from becoming trapped.

The control device 16 is also used to operate a door lock 18 and to monitor whether the door 8 can be locked to the body 6 or whether the locking system can be overridden. For this purpose, the current position of the door 8 with respect to the body 6 is checked, for which purpose a plurality of sensors/switches, not illustrated, are used, these being signally connected to the control device 16. The control device 16 is also connected to an electrically adjustable side mirror 20, which is also operated by means of the control device 16. Here, too, appropriate (setpoint) specifications for the actuators, such as electric motors, of the electrically adjustable side mirror 20 are specified by means of the control device 16. In addition, a heating system of a mirror of the electrically adjustable side mirror 20 is controlled by means of the control device 16.

An input apparatus 22, which is connected to the interior paneling of the door 8, is also signally connected to the control device 16, such that said input apparatus can be activated from inside the motor vehicle 2. The input apparatus 22 has a plurality of switches, specifically buttons, each of which is associated with at least one of the electromotive window lifter 14, the door lock 18 and the electrically adjustable side mirror 20. By means of the input apparatus 22, it is therefore possible for a user to activate each of these and the input apparatus 22 is provided and set up for this purpose.

The control device 16 is also signally connected to a bus system 24, which is a CAN bus system. In this case, the control device forms a slave device of the bus system 24, and an on-board computer 26, which is also connected to the bus system 44, constitutes the master device thereof. It is therefore possible to exchange data between the on-board computer 26 and the control device 16 via the bus system 24.

FIG. 2 shows a schematically simplified view of the control device 16. The control device 16 comprises a first interface 28, to which the bus system 24 is connected. The first interface 28 is signally connected to a microcontroller 30, which comprises a microprocessor with several cores. The microcontroller 3 also comprises an internal storage unit. The microcontroller 30 is signally connected to a second interface 32, to which a subsidiary bus system 34 is connected. In this case, the subsidiary bus system 34 is also, for example, a CAN bus system or, for example, a LIN bus system, and the control device 16, in particular the microcontroller 30, functions as master of the subsidiary bus system 34. The subsidiary bus system 34 is signally connected only to constituent parts of the door 8, such as a control unit, not illustrated in any more detail, of the electrically adjustable side mirror 20 and/or sensors.

Two inputs 36 are also connected to the microcontroller 30, one sensor being connected to each of said inputs in the assembled state, each of said sensors not being a direct constituent part of the control device 16. Three driver modules 38 of the control device 16 are also connected to the microcontroller 30, said driver modules being operated by means of the microcontroller 30. Each of the driver modules 38 is signally connected to a respectively assigned output 39, to which a respective bridge circuit, specifically a B6 circuit, is connected in the assembled state. In this case, one of the bridge circuits is assigned to the electrically adjustable side mirror 20, another is assigned to the door lock 18 and another is assigned to the electric motor 12 of the electromotive window lifter 14, such that in each case a brushless electric motor or the electric motor 12 can be energized thereby.

The control device 16 also comprises another microcontroller 40, to which computation operations can be transferred from the microcontroller 30. Furthermore, the microcontroller 30 is connected to a first storage unit 42 and a second storage unit 44 of the control device 16. In this case, operating data and/or error messages are stored by means of the first storage unit 42. A neural network 46 is stored in the second storage unit 22.

FIG. 3 shows a schematically simplified view of a method 48 for operating the control device 16, said method being carried out at least in part by means of the microcontroller 30. For this purpose, for example, a computer program product, which contains appropriate commands and which is stored in the second storage unit 44, is executed. The neural network 46 is also used to execute the method 48. As a result, the control device 16 is operated in accordance with the method 48.

In a first working step 50, current requirements 52 for the control device 16 are determined by means of the microcontroller 30. For this, it is checked whether a request to operate the electromotive window lifter 14, the door lock 18 or the electrically adjustable side mirror 20 is present via the bus system 24 or the subsidiary bus system 34. It is also checked whether the input apparatus 22 has been activated. In addition, the signals applied to the inputs 36 are analyzed and evaluated. In summary, when the current requirements 52 are determined, it is checked whether the constituent parts of the door 8, which are operated by means of the control device 16, are to be operated or are currently being operated. In other words, it is checked whether a task or other activity is to be carried out or is currently being carried out by means of the control device 16.

In addition, other messages received via the bus system 24 are analyzed and evaluated, and the current requirements 52 are adapted in a manner dependent thereon, with a neural network 46 being used at least in part for this. Thus, for example, the process of setting a standby mode is used as the current requirement 52 when, for example, a corresponding notification is transmitted from the on-board computer 26 via the bus system 24 to the control device 16 or to other participants of the bus system 24.

In addition, the current requirements 52 are otherwise processed by means of the neural network 46. In this case, the neural network 46 is used to determine the probability of the occurrence of current requirements 52 that go beyond operating system tasks and housekeeping functions of the microcontroller 30, and, if the probability is greater than a particular value, the preparation for this is used as the current requirement 52.

If there are current requirements 52 that go beyond operating system tasks and housekeeping functions of the microcontroller 30, these are processed by means of the microcontroller 30 and the other constituent parts of the control device 16. For this purpose, a clock frequency 54 of the microcontroller 30, the time profile of which is shown in FIG. 4, is initially left at a first level 56, which corresponds to a maximum clock frequency 54 of the microcontroller 30. In this example, the first level 56 corresponds to 120 MHz. On account of this clock frequency 54, the individual tasks of the current requirements 52 are processed relatively quickly. For more rapid processing, individual tasks or at least particular computation operations are transferred to the other microcontroller 40.

If the current requirements 52 include energization and operation of one of the converters, the corresponding driver modules 38 are operated by means of the microcontroller 30. Operating data and any error messages are also stored in the first storage unit 42. The subsidiary bus system 34 is operated by way of the second interface 32, such that data is exchanged with the components that are connected thereto.

The current requirements 52 are checked continuously. If at a first time 58 there are no longer any current requirements 52 that go beyond operating system tasks and housekeeping functions of the microcontroller 30, that is to say, in particular, the electromotive window lifter 40, the door lock 18 or the electrically adjustable side mirror 20 is not to be operated, the input apparatus 22 is not activated, and no requirements or other tasks are transmitted via the bus system 24 to the control device 16 either, it is checked whether the neural network 46 is trained. If this is not the case, this is used as the current requirement 52, which is maintained until either the neural network 46 is trained or a current requirement 52, which is different therefrom and which goes beyond operating system tasks and housekeeping functions of the microcontroller 30, arises at the control device 16.

In contrast, if the neural network 46 is trained at the first time 58 and there are no current requirements 52 that go beyond operating system tasks and housekeeping functions of the microcontroller 30 either, a second working step 60 is carried out. In the second working step 60, the first level 56 is initially retained as clock frequency 54 for a period of time 62 that is 100 ms. If current requirements 52 additionally arise within this period of time 62, the first working step 50 is carried out again and the additional current requirements 52 are processed.

Otherwise, a third working step 64 is carried out. In this working step, the clock frequency 54 is lowered to a second level 66, which is 30 MHz. Peripheral devices, specifically the first storage unit 42, the driver modules 38, the other microcontroller 40, the second interface 32 and thus also the complete subsidiary bus system 34 are also switched off, that is to say the operating mode thereof is changed so that there is no longer an energy demand there. In other words, the operating mode of the peripheral devices 32, 38, 40, 42 is changed depending on the current requirements 52. Tasks are processed by means of the microcontroller 30 more slowly on account of the reduced clock frequency 54 of the microcontroller 30. However, since only the operating system tasks and housekeeping functions exist as current requirements 52, this is sufficient. When the current requirement 52 additionally comprises only responding to status queries transmitted via the bus system 24, the clock frequency 54 is not changed either. The response to status queries via the bus system 24 therefore also takes place in the third working step 64. In contrast, if additional current requirements 52 arise, the first working step 50 is executed again and said requirements are processed.

If no additional current requirements 52 arise after a particular period of time, specifically 5 seconds, a fourth working step 66 is carried out. In this working step, a self-test 68 is added to the current requirements 52, such that there are now additional current requirements 52. As a result, the first working step 50 is carried out again and the additional current requirements 52, specifically the self-test 68, are processed. For this purpose, the clock frequency 54 is raised again to the first level 56, such that processing of the self-test 68 is accelerated.

In the self-test 68, the inputs 36 are retrieved by the microcontroller 30 and the first memory unit 42 and the other microcontroller 40 are temporarily transferred to an operating state and an appropriate test routine is initiated thereon. In addition, self-test routines of the microcontroller 30 are carried out. After the self-test 68 has been processed, if there are no other current requirements 52 with the exception of the operating system tasks and the housekeeping functions of the microcontroller 30, the second working step 60 is carried out again, but with the period of time 62 being reduced to 0 seconds. Therefore, the clock frequency 54 is reduced again and the operating mode of the peripheral devices 40, 42 is changed. On account of the hardware of the control device 16, the period in which the clock frequency 54 is at the first level 56 is 150 ms. Consequently, the self-test 68 is used cyclically as a current requirement 52, such that the clock frequency 54 is always raised to the first level 56 and subsequently lowered to the second level 66 every 5 seconds in order to carry out the self-test 68. For the self-test 68, in this case the operating mode of some of the peripheral devices 28, 32, 38, 40, 44 is also changed.

If additional current requirements 52 that do not correspond to the self-test 68 or the operating system tasks/housekeeping functions exist at a second time 70, the clock frequency 54 is essentially immediately increased from the second level 66 to the first level 56 and the first working step 50 is executed.

In summary, therefore, the clock frequency 54 of the microcontroller 30 is adapted depending on the current requirements 52, where the current requirements 53 are determined continuously. If only the self-test 68 is present as the current requirements 52, with the exception of the operating system tasks/housekeeping functions, after said current requirements have been processed, the clock frequency 54 is essentially immediately reduced. Otherwise, the clock frequency 54 is reduced only after the period of time 62. The evaluation of whether current requirements 52 are present is carried out at least in part by means of the neural network 46 by virtue of probabilities being determined. The neural network 46 is therefore used to adapt the clock frequency 54 depending on the current requirements 52.

The invention is not restricted to the exemplary embodiment described above. On the contrary, other variants of the invention may also be derived therefrom by a person skilled in the art without departing from the subject matter of the invention. All of the individual features described in connection with the exemplary embodiment may, in particular, also be combined with one another in other ways without departing from the subject matter of the invention.

### LIST OF REFERENCE SIGNS

2 motor vehicle
4 wheel
6 body
8 door
10 windowpane
12 electric motor
14 electromotive window lifter
16 control device
18 door lock
20 electrically adjustable door mirror
22 input apparatus
24 bus system
26 on-board computer
28 first interface
30 microcontroller
32 second interface
34 subsidiary bus system
36 input
38 driver modules
39 output
40 other microcontroller
42 first storage unit
44 second storage unit
46 neural network
48 method
50 first working step
52 current requirements
54 clock frequency
56 first level
58 first time
60 second working step
62 period of time
64 third working step
68 self-test
70 second time

1-8. (canceled)

9. A method for operating a control device of a motor vehicle, the control device including a microcontroller, the method comprising:
determining current requirements for the control device by way of the microcontroller; and
adjusting a clock frequency of the microcontroller in dependence on the current requirements.

10. The method according to claim 9, which comprises determining the current requirements continuously.

11. The method according to claim 9, which comprises reducing the clock frequency only after a given period of time.

12. The method according to claim 9, which comprises cyclically using a self-test as the current requirement.

13. The method according to claim 9, which comprises adapting the current requirements depending on messages received via a bus system.

14. The method according to claim 9, which comprises also changing an operating mode of a peripheral device in dependence on the current requirements.

15. The method according to claim 9, which comprises using a neural network to adjust the clock frequency depending on the current requirements.

16. The method according to claim 9, wherein the control device is a door control device of the motor vehicle, and the method comprises adapting the clock frequency of the door control device depending on current requirements.

17. A control device of a motor vehicle, the control device comprising a microcontroller configured to operate in accordance with the method according to claim 9.

18. The control device according to claim 17 configured as a door control device of the motor vehicle.
